(19) United States
(12) Patent Application Publication
(10) Pub. No.: US 2011/0014821 A1
(43) Pub. Date: Jan. 20, 2011

(54) CABLE CONNECTOR ASSEMBLY

(75) Inventor: David Ko, Fullerton, CA (US)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/839,429

(22) Filed: Jul. 20, 2010

(30) Foreign Application Priority Data
Jul. 20, 2009 (CN) 200920306489.X

(51) Int. Cl. H01R 13/46

(52) U.S. Cl. 439/733.1

(57) ABSTRACT

A cable connector assembly (100) comprises a body portion (1) comprising a first connector (15) and a second connector (16), an insulative housing (2) connecting with the body portion (1) and a cable (5) comprising a set of wires (51). The body portion (1) has a first and second soldering tails (12, 13). The first and second soldering tails (12, 13) are retained on a rear end of the first and second connectors (15, 16) and have two pairs of soldering members (123, 133). Two pairs of the soldering members (123, 133) form a first and second bridges (18, 19) respectively, the wires (51) electrically connect with the first and second connectors (15, 16) via the wires (51) soldering with the first and second bridges (18, 19).

### BACKGROUND OF THE INVENTION

1. Field of the Invention

This application claims priority to prior Chinese patent applications 200920306489.X, the disclosure of which is incorporated herein by reference.

The present invention generally relates to a cable connector assembly, and more particularly to a cable connector assembly having two cylindrical connectors.

2. Description of Related Art

Conventional cable connector assemblies are widely used in an electronic equipment, especially for transmitting power, and the performance of the cable connector assembly directly impacts on the entire electronic equipment.

A cable connector assembly is a power connector and comprises a first connector and a second connector. An insulative housing is over-molded with the first and second connectors. A power contact is received in the first connector. A signal contact is received in the second connector. A plurality of wires electrically connect with the contacts. An insulative cover covers the first and second connectors. The insulative housing conjuncts the first connector with the second connector along a transverse direction. The first and second connectors each comprises an outer tube and an inner tube spaced apart from the outer tube along a radius direction thereof. The wires include two positive wires and some negative wires. The two inner tubes electrically connect with the two positive wires respectively. The outer tubes electrically connect with the negative wires. However, when one of the wires is disconnected with one of the inner tube, the cable connector assembly will be out of work. Besides, the positive wires need to be welded into the inner tubes twice, so it need more time to finish welding the positive wires into the inner tubes and it will be a waste of time and material.

Hence, an improved cable connector assembly is desired to overcome the above problems.

### BRIEF SUMMARY OF THE INVENTION

According to one aspect of the present invention, a cable connector assembly comprises: a body portion comprising a cylindrical first connector and a cylindrical second connector, an insulative housing connecting with the body portion, a cable connected with the body portion and comprising a set of wires and an insulative cover over-molded on an electrical connection area between the body portion and the insulative housing; the first and second connectors each having at least a tail retained on a rear end of the first and second connectors, each tail having a soldering member extending from one side thereof, each pair of the soldering members forming a conductive bridge; wherein at least a wire electrically connects with the first and second connectors via the wire soldering with the conductive bridge.

According to another aspect of the present invention, a cable connector assembly for mating with a corresponding receptacle connector, comprising: a body portion comprising a first connector and a second connector arranged side by side along a transverse direction, an insulative housing connecting with the body portion, and comprising a supporting portion for supporting the first and second soldering tails, a cable connected with the body portion and comprising a set of wires and an insulative cover over-molded on an electrical connection area between the body portion and the insulative housing; the first and second connectors each having a first soldering tail and a second soldering tail, a first bridge locating between the first soldering tails, a second bridge locating between the second soldering members; wherein the wires electrically connects with the first and second connectors via the wires soldering with the first and second bridges.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

FIG. 1 is an assembled, perspective view of a cable connector assembly in the present invention;

FIG. 2 is similar to FIG. 1, but viewed from another aspect;

FIG. 3 is a partly exploded, perspective view of the cable connector assembly;

FIG. 4 is similar to FIG. 3, but viewed from another aspect;

FIG. 5 is an exploded, perspective view of the cable connector assembly;

FIG. 6 is similar to FIG. 5, but viewed from another aspect; and

FIG. 7 is an assembled, perspective view of a body portion, contacts and cable wires of the cable connector.

### DETAILED DESCRIPTION OF THE INVENTION

Reference will now be made to the drawing figures to describe the present invention in detail.

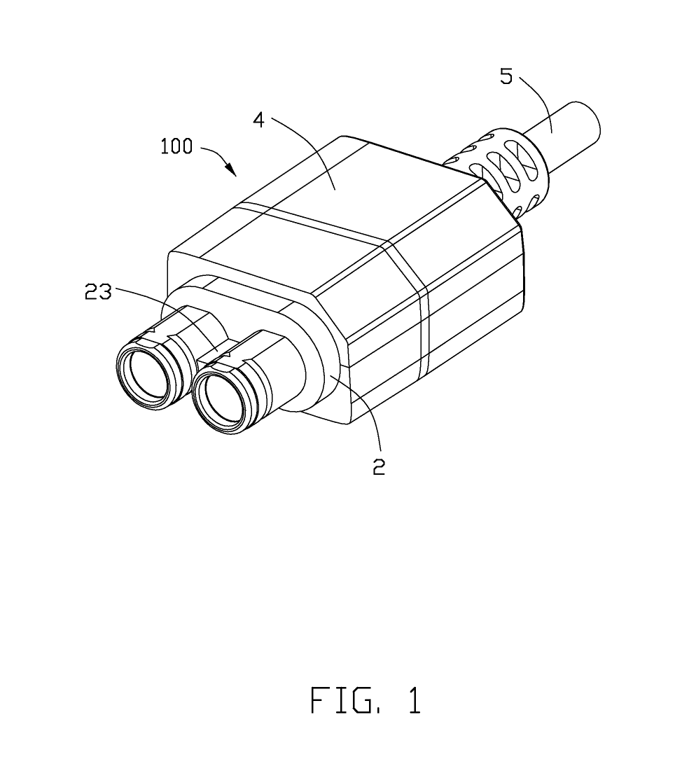

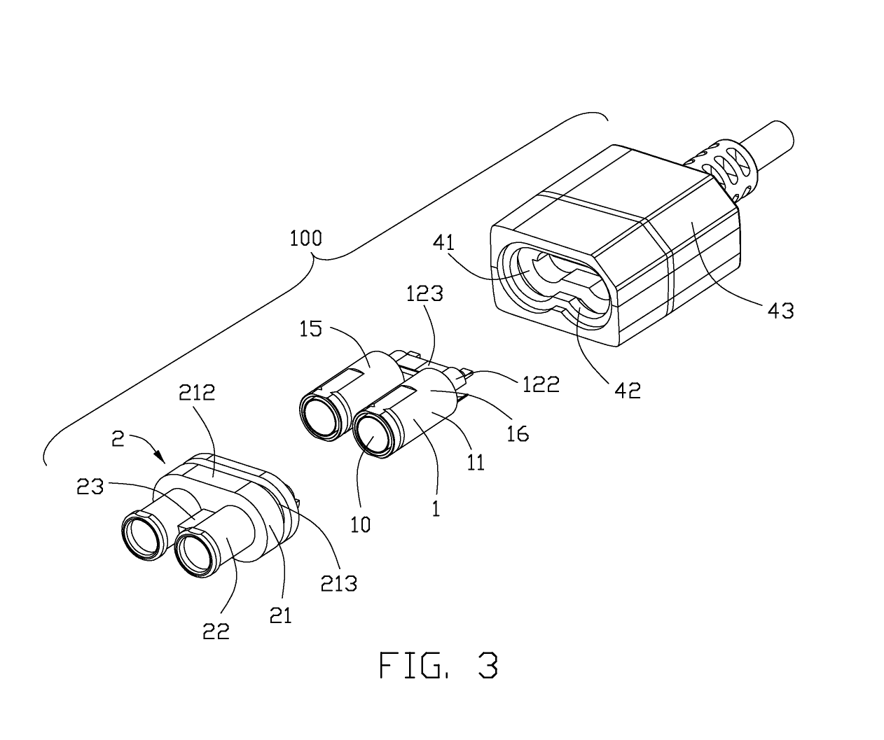

Referring to FIGS. 1-7, a cable connector assembly 100 in accordance with the present invention comprises a body portion 1, an insulative housing 2 being formed integrally with the body portion 1, a plurality of contacts 3 retained in the insulative housing 2, an insulative cover 4 and a cable 5 connected with the body portion 1. The insulative cover 4 is over-molded on an electrical connection area between the body portion 1 and the cable 5. The insulative cover 4 covers part of the body portion 1 and the insulative housing 2. The cable has a set of wires 51, the contacts 3 are connected with the wires 51. The cable connector assembly 100 is mating with a corresponding receptacle connector which is not showed in any figs.

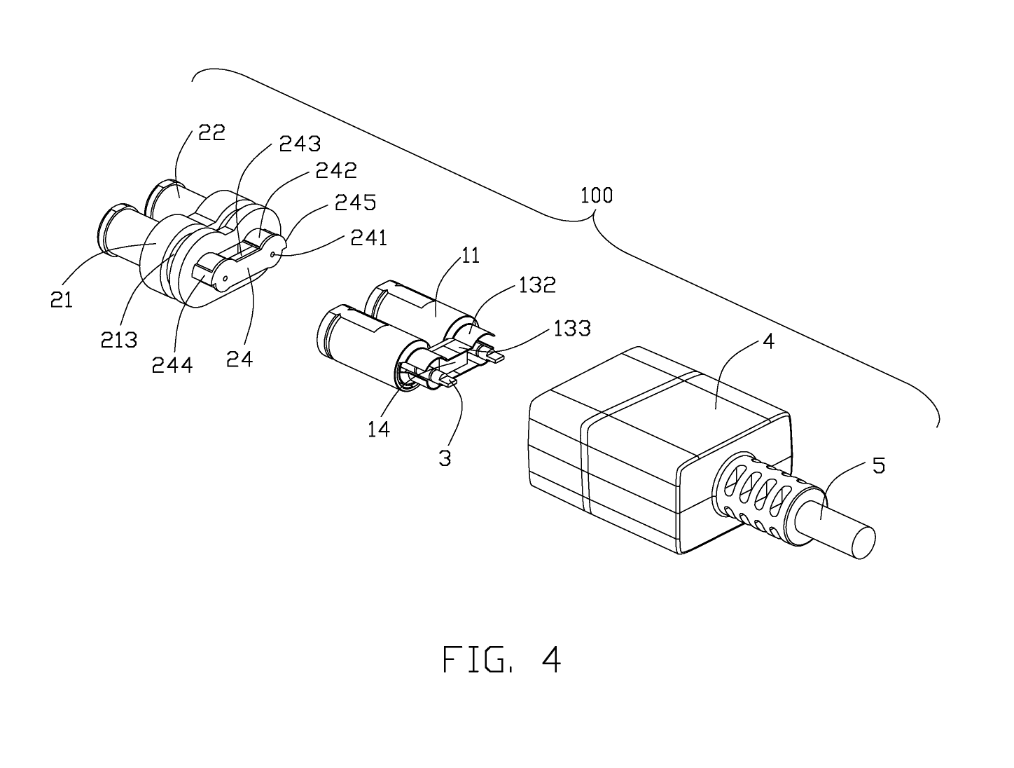

Referring to FIGS. 4-6, the body portion 1 presents as a telescope shape, the body portion 1 comprises a cylindrical first connector 15 and a cylindrical second connector 16. The contacts 3 are located at central axises of the first and second connectors 15, 16. The first and second connectors 15, 16 extend along a back to front direction. The first and second connectors 15, 16 each comprises an outer tube 11 and an inner tube 10 spaced apart from the outer tube 11 along a radius direction thereof. A diameter of the outer tube 11 is bigger than a diameter of the inner tube 10. A space 17 is formed between the outer tube 11 and the inner tube 10 for receiving the corresponding portion of the insulative housing 2.

Referring to FIGS. 4-6, the body portion 1 further comprises a set of tails retained on a rear end of the first and second connectors 15, 16. The tails include a pair of first soldering tails 12 retained on the rear end of the first and second connectors 15, 16 respectively and a pair of second soldering tails 13 retained on the rear end of the first and second connectors 15, 16 respectively. The first soldering tails 12 correspondingly connect with the two inner tubes 10. The second soldering tails 13 correspondingly connect with the two outer tubes 11. The two first soldering tails 12 are arranged along a left to right direction. The two second soldering tails 13 also are arranged along the left to right direction.

Referring to FIGS. 4-6, the first and second soldering tails 12, 13 each has a cylindrical connecting portion located in front thereof and curving from one end of a metal piece, an arc engaging portion extending from a sidewall of the connecting portion along a front to end direction and a soldering member extending from one side of the arc engaging portion. Each pair of the soldering members form a conductive bridge. The wires 51 electrically connect with the first and second connectors 15,16 via soldering with the conductive bridges.

Referring to FIGS. 4-6, The cylindrical connecting portions include a first cylindrical connecting portions 121 formed on the first soldering tail 12 and a second cylindrical connecting portion 131 formed on the second soldering tail 13. The arc engaging portions include a first arc engaging portion 122 formed on the first soldering tail 12 and a second arc engaging portion 132 formed on the second soldering tail 13. The soldering members include a first soldering member 123 formed on the first soldering tail 12 and a second soldering member 133 formed on the second soldering tail 13. The conductive bridges comprise a first bridge 18 and a second bridge 19. The first soldering members 123 of the first soldering tails 12 form the first bridge 18. The second soldering members 133 of the second soldering tails 13 form the second bridge 19. The first and second bridges 18, 19 are arranged along a vertical direction. The body portion 1 further comprises a plastic block 14 which is located between the first and second bridges 18, 19 for supporting the first and second bridges 18, 19. Therefore, the welding process is convenient. The plastic block can prevent the first and second soldering tails 12, 13 from moving when the body portion 1 is insert-molded with the insulative housing 2.

Referring to FIGS. 4-6, there is a first gap formed between the pair of first soldering members 123 before the two first soldering members 123 being welded together. Similarly, there is a second gap formed between the pair of second soldering members 133 before the two second soldering members 133 being welded together. A length of the first arc engaging portion 122 or the second arc engaging portion 132 is longer than a length of the first connecting portion 121 or the second connecting portion 131 along the front to rear direction. An expanding length of the first connecting portion 121 or the second connecting portion 131 is longer than the first arc engaging portion 122 or the second arc engaging portion 132 along horizontal direction. Therefore, the welding area is larger, the first and second connecting portion 121, 131 strengthen with the first and second connectors 15, 16 stably.

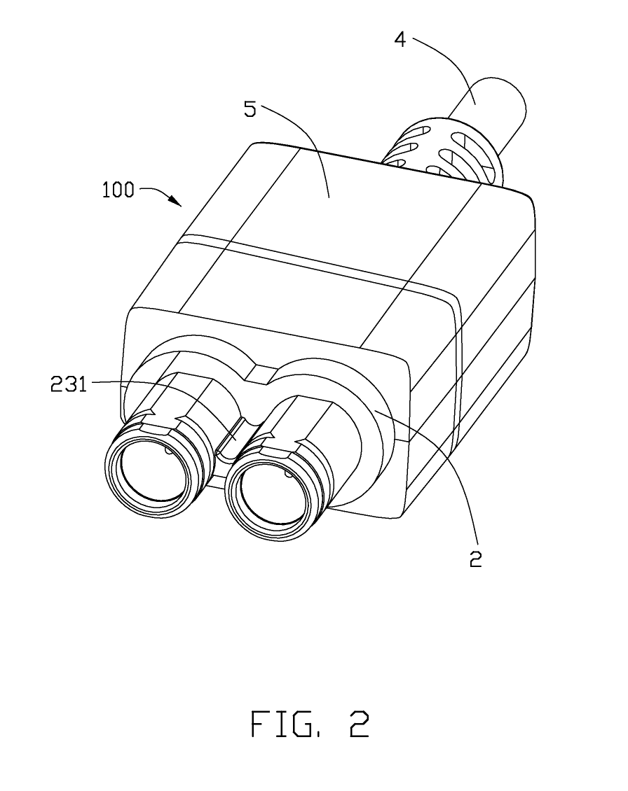

Referring to FIGS. 1-2, the insulative housing 2 presents as a telescope shape and is made of plastic material. The insulative housing 2 is insert-molded with the body portion 1. The insulative housing 2 includes a base 21, a pair of tubal portions 22 extending forwardly from the base 21, an extending portion 23 extending along the back to front direction perpendicular to the transverse direction and a supporting portion 24 located at the back of the base 21 for supporting the first and second soldering tails 12, 13. The base 21 includes a top surface 211, a bottom surface 212 and a recess 213 depressed around the surface thereof. A first groove 2110 is formed in the middle of the top surface 211 and extends along the front to rear direction. The first groove 2110 is aligned with the extending portion 23 along the front to rear direction. The bottom surface 212 is flat. Front ends of the outer and inner tubes 11, 10 resist front ends of the two tubal portions 22 respectively.

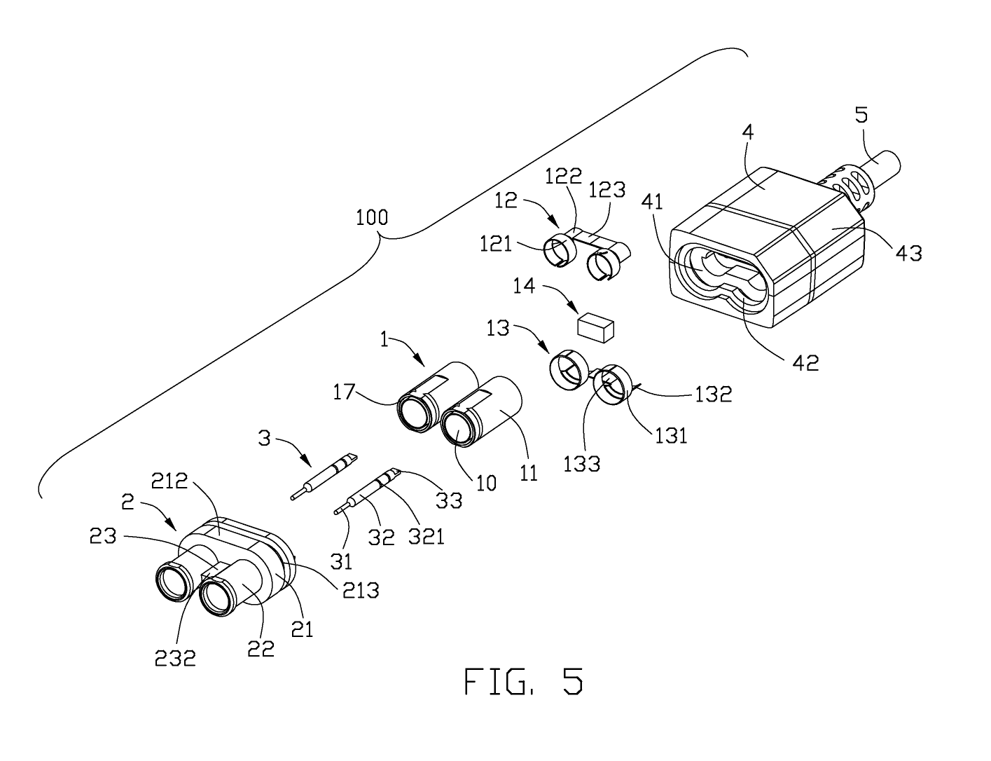

Referring to FIG. 2 and FIG. 5, the extending portion 23 locates between the two tubal portions 22. The extending portion 23 includes a curved groove 231 at one side thereof and a flat surface 232 at another side thereof. The curved groove 231 extends along the back to front direction. The extending portion 23 does not extend beyond a front end of the two tubal portions 22 along the back to front direction. Thereby the extending portion 23 distinguishes the cable connector assembly 100 from normal connector which does not have said extending portion 23, and facilitates replacement of the cable connector assembly 100. Besides, the extending portion 23 defines the curved groove 231 which is easily to be changed for defining next generation of the cable connector assembly 100.

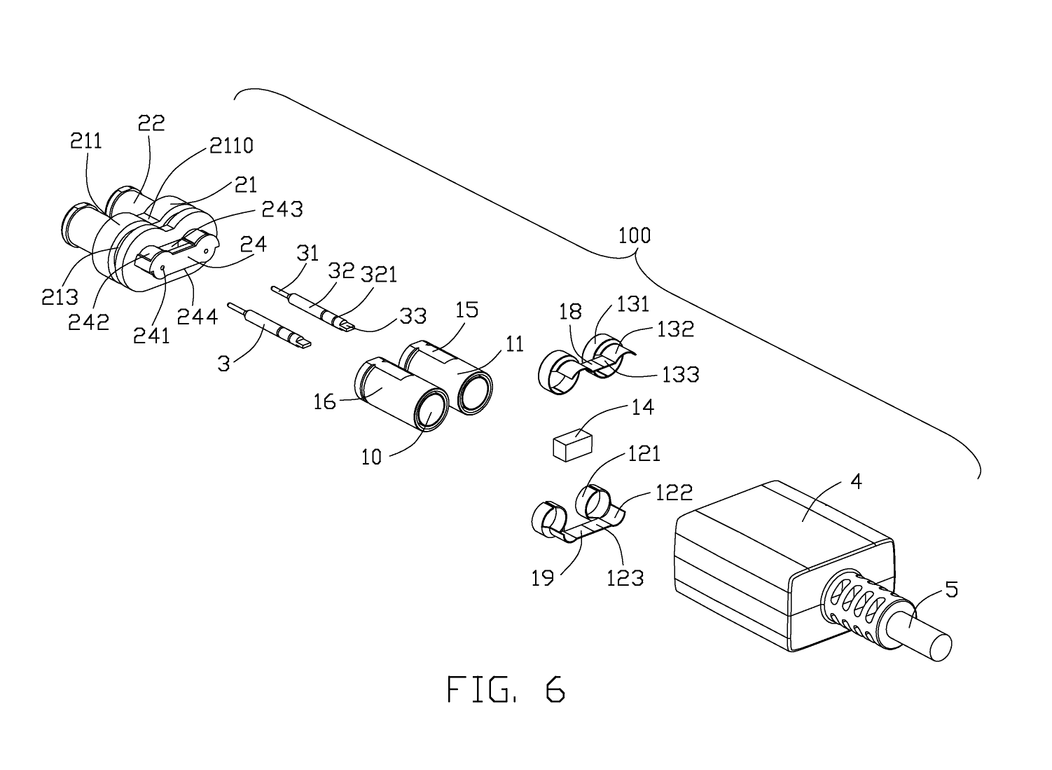

Referring to FIG. 4 and FIG. 6, the supporting portion 24 comprises a pair of holes 241 extending along the front to back direction for receiving contacts, two pairs of arc supporting portions 242 for supporting the first and second arc engaging portions 122, 132 and a flat supporting portion 243 connecting the arc supporting portions 242 for supporting the first and second bridges 18, 19. The two pairs of arc supporting portions 242 locate in top and bottom surfaces of the supporting portion 24 respectively. The top surface of the supporting portion 24 is similar to the bottom surface of the supporting portion 24.

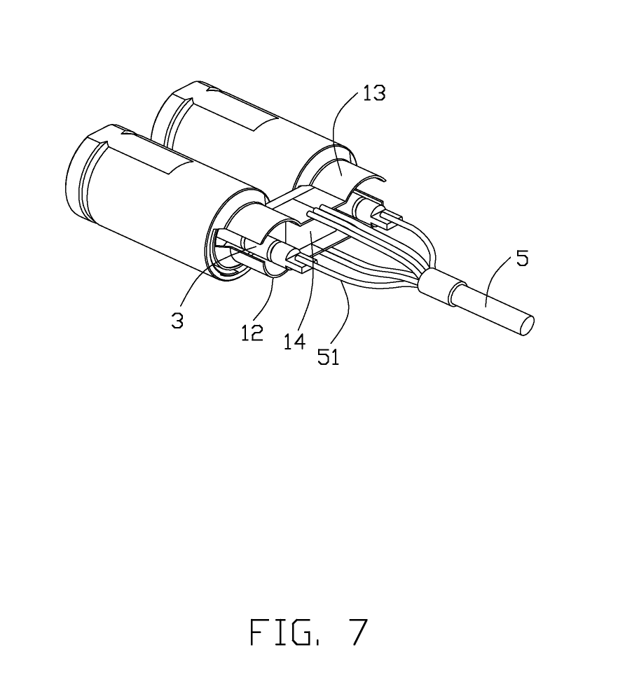

Referring to FIG. 4 and FIG. 7, the plastic block 14 is sandwiched between the first and second bridges 18, 19 along an up to down direction. The contact 3 includes a power contact and a signal contact, the plastic block 14 is located between the power contact and the signal contact along a left to right direction. The supporting portion 24 further includes a left protrusion 244 and a right protrusion 245. The left and right protrusions 244, 245 are located at two sides of the supporting portion 24 respectively. The left protrusion 244 connects the first and second arc engaging portions 122, 132 along the up to down direction. The upper side of the left protrusion 244 abuts against the left side end of the first arc engaging portion 122. The lower side of the left protrusion 244 abuts against the left side end of the second arc engaging portion 132. The right protrusion 245 has a structure which is same to the left protrusion 244. The right protrusion 245 connects the first and second arc engaging portions 122, 132 along the up to down direction. The upper side of the right protrusion 245 abuts against the right side end of the first arc engaging portion 122. The lower side of the right protrusion 245 abuts against the right side end of the second arc engaging portion 132. In this way, the plastic block 14 avoids the first bridge 18 connecting with the second bridges 19. The left protrusion 244 prevents the left side end of the first arc engaging portion 122 connecting with the left side end of the second arc engaging portion 132. The right protrusion 245 prevents the right side end of the first arc engaging portion 122 connecting with the right side end of the second arc engaging portion 132. The power and signal contacts is located between the first and second arc engaging portions 122, 132 along the up to down direction respectively.

Referring to FIGS. 5-6, the power contact is used for transmitting power and the signal contact is used for transmitting signal. The contacts 3 are made of conductive material. The contacts 3 each comprises a soldering portion 33 in a back end thereof, a contacting portion 31 in a front end thereof and a middle portion 32 connecting the contacting portion 31 and the soldering portion 33, the soldering portions 33 define a diameter which is larger than that of the corresponding contacting portions 31. The contacts 3 define a plurality of second grooves 321 recessed from an outer surface thereof for engaging with the insulative housing 2 to enhance the combinations between the contact 3 and the insulative housing 2. The soldering portions 33 extend out of the insulative housing 2 along the front to rear direction. The contacting portions 31 are exposed in the body portion 1.

Referring to FIG. 5, the insulative cover 4 is assembled to an outer side of the insulative housing 2 and the cable 5. The insulative cover 4 is made of plastic material. The insulative cover 4 includes a receiving cavity 41 recessed from a front end thereof, an annular projection 42 extending into the receiving cavity 41 from the inner surface thereof and a bevel 43 formed in one side of the insulative cover 4. The receiving cavity 41 receives the body portion 1 and the insulative housing 2. The bevel 43 can prevent the insulative cover 4 from mismating with the receptacle connector.

Referring to FIG. 7, the cable 5 comprises six wires 51 connected with the first and second connectors 15, 16 and a grounding wire. The two conductors of the six wires 51 are electrically connected with the first soldering tails 12. Therefore, when one of the wires 51 disconnects with the first soldering tails 12, the other wires 51 can maintain the connection between the two first soldering tails 12. Besides, the two wires 51 are received in the first gap which is formed between the pair of the first soldering members 123 and are welded with the pair of the first soldering members 123, it needs one time to weld the wires 51 into the first soldering tail 12, so it needs less time to finish welding the wires 51 with the first soldering tails 12, compared with the related art, it saves cost.

Another two wires of the six wires 51 are electrically connected with the contact 3. The other two wires of the six wires 51 and the grounding wire are electrically connected with the second soldering tails 13. Therefore, when one of the wires 51 disconnects with the second soldering tails 13, the other wire can maintain the connection between the two second soldering tails 13. Besides, the two wires 51 are received in the second gap which is formed between the pair of the second soldering members 133 and are welded with the pair of the second soldering members 123, it needs one time to weld the wires with the second soldering tail 13, so it needs less time to finish welding the wires 51 with the second soldering tails 13, compared with the related art, it saves cost.

In assembly, firstly, assembling the first and second soldering tails 12, 13 to the first and second connectors 15, 16 respectively; Secondly, insert-molding the insulative housing 2 to the body portion 1; Thirdly, connecting the wires 5 with the first and second soldering tails 12, 13 to the contacts 3; Lastly, over-molding the insulative shell 4 to the body portion 1 and the cable 5, then the annular projection 42 is received in the recess 213.

As described above, the cable connector assembly 100 further includes the first and second soldering tails 12, 13 at the back of the first and second connectors 15, 16. The first soldering tails 12 correspondingly connect with the two inner tubes 10. The second soldering tails 13 correspondingly connect with the two outer tubes 11. Two pairs of the wires 51 connect with the first soldering tail 12 and second soldering tail 13 respectively. Therefore, when one of the wires 51 disconnects with the first soldering tails 12 or one of the wires 51 disconnects with the second soldering tails 13, the other wires 51 can maintain the connection between the two first soldering tails 12 or two second soldering tails 13. Besides, the two pairs of wires 51 are received in the first gap and the second gap respectively, it needs one time to weld the wires 51 with the first soldering tails 12 or the second soldering tails 13, so it needs less time to finish welding the wires 51 with the first soldering tails 12, compared with the related art, it saves cost.

As described above, the cable connector assembly 100 further includes the extending portion 23. Thereby the extending portion 23 distinguishes the cable connector assembly 100 from normal connector which does not have said extending portion 23, and facilitates replacement of the cable connector assembly 100. Besides, the extending portion 23 defines the curved groove 231 which is easily to change for defining next generation of the cable connector assembly 100.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A cable connector assembly, comprising:
a body portion comprising a cylindrical first connector and a cylindrical second connector, the first and second connectors each having at least a tail retained on a rear end of the first and second connectors, each tail having a soldering member extending from one side thereof, each pair of the soldering members forming a conductive bridge;
an insulative housing connecting with the body portion;
a cable connected with the body portion and comprising a set of wires; and
an insulative cover over-molded on an electrical connection area between the body portion and the insulative housing;
wherein at least a wire electrically connects with the first and second connectors via the wire soldering with the conductive bridge.

2. The cable connector assembly as claimed in claim 1, wherein the first and second connectors each comprises an outer tube and an inner tube spaced apart from the outer tube along a radius direction thereof, the tails comprise a pair of first soldering tails retained on the rear end of the first and second connectors respectively and a pair of second soldering tails retained on the rear end of the first and second connectors respectively, the first soldering tails correspondingly connect with the two inner tubes, the second soldering tails correspondingly connect with the two outer tubes.

3. The cable connector assembly as claimed in claim 2, wherein the cable connector assembly further comprises a set of contacts electrically connecting with the wires, the contacts are located between the first and second soldering tails.

4. The cable connector assembly as claimed in claim 3, wherein the first and second soldering tails have at least a cylindrical connecting portion located in front and curving from one end of a metal piece and an arc engaging portion extending from a sidewall of the connecting portion along a front to rear direction.

5. The cable connector assembly as claimed in claim 4, wherein a length of the arc engaging portion is longer than a length of the connecting portion along the front to rear direction.

6. The cable connector assembly as claimed in claim 4, wherein the conductive bridge comprises a first bridge and a second bridge, the two soldering members of the first soldering tails form the first bridge, the two soldering members of the second soldering tails form the second bridge, the first and second bridges are arranged along a vertical direction.

7. The cable connector assembly as claimed in claim 6, wherein the body portion further comprises a plastic block which is sandwiched between the first and second bridges along an up to down direction, the plastic block is also located between the contacts along a left to right direction.

8. The cable connector assembly as claimed in claim 1, wherein the insulative housing comprises a base, a pair of tubal portions extending forwardly from the base and a supporting portion located at back of the base for supporting the tails.

9. The cable connector assembly as claimed in claim 8, wherein the supporting portion comprises a pair of arc supporting portions for supporting the two arc engaging portions and a flat supporting portion connecting the two arc supporting portions and supporting the conductive bridges, the contacts each is located between the two arc supporting portions.

10. The cable connector assembly as claimed in claim 9, wherein the supporting portion further includes a left protrusion, the left protrusion connects the two arc engaging portions along the up to down direction the upper side of the left protrusion abuts against a left side end of one of the arc engaging portion, the lower side of the left protrusion abuts against the left side end of the other arc engaging portion.

11. A cable connector assembly, for mating with a corresponding receptacle connector, comprising:
a body portion comprising a first connector and a second connector arranged side by side along a transverse direction, the first and second connectors each having a first soldering tail and a second soldering tail, a first bridge locating between the first soldering tails, a second bridge locating between the second soldering members;
an insulative housing connecting with the body portion, and comprising a supporting portion for supporting the first and second soldering tails;
a cable connected with the body portion and comprising a set of wires; and
an insulative cover over-molded on an electrical connection area between the body portion and the insulative housing;
wherein the wires electrically connects with the first and second connectors via the wires soldering with the first and second bridges.

12. The cable connector assembly as claimed in claim 11, wherein the first and second connectors each comprises an outer tube and an inner tube spaced apart from the outer tube along a radius direction thereof, the first soldering tails correspondingly connect with the two inner tubes, the second soldering tails correspondingly connect with the two outer tubes.

13. The cable connector assembly as claimed in claim 11, wherein the first and second soldering tails have at least a cylindrical connecting portion located in front and curving from one end of a metal piece and an arc engaging portion extending from a sidewall of the connecting portion along a front to rear direction, a length of the arc engaging portion is longer than a length of the connecting portion along the front to rear direction.

14. The cable connector assembly as claimed in claim 11, wherein the body portion further comprises a plastic block which is sandwiched between the first and second bridges along an up to down direction.

15. The cable connector assembly as claimed in claim 11, wherein the insulative housing comprises a base, a pair of tubal portions extending forwardly from the base, a supporting portion located at back of the base for supporting the tails and an extending portion extending along a back to front direction perpendicular to the transverse direction, the extending portion located between the two tubal portions.

16. A cable connector assembly comprising:
a first connector and a second connector side by side arranged with each other in a transverse direction while each of said first connector and said second connector extending in a front-to-back direction perpendicular to said transverse direction,
each of said first connector and said second connector including coaxially an conductor inner tube functioning as an anode and a conductive outer tube functioning as a cathode and a center contact transmitting signal;
a pair of solder tails including a pair of first rings linked by a first bridge behind said pair of first rings in said front-to-back direction under condition that said pair of first rings are respectively circumferentially engaged with the corresponding inner tubes of said first connector and said second connector;
a pair of second solder tails including a pair of second rings linked by a second bridge behind said pair of second ring in said front-to-back direction under condition that that said pair of second rings are respectively circumferentially engaged with the corresponding outer tubes of said first connector and said second connector; and
a plurality of wires categorized with first, second and third groups; wherein
the wires of the first group are commonly mechanically and electrically connected to the first bridge, those of the second group are commonly mechanically and electrically connected to the second bridge, and those of the third group are respectively mechanically and electrically connected to the corresponding center contacts.

17. The cable connector assembly as claimed in claim 16, wherein the first bridge defines two opposite first side arced potions and a first middle straight portion in said transverse direction under condition that said first arced portions forwardly are respectively linked to the corresponding inner tubes.

18. The cable connector assembly as claimed in claim 16, wherein the second bridge defines two opposite second side arced potions and a second middle straight portion in said transverse direction under condition that said second arced portions forwardly are respectively linked to the corresponding outer tubes.

19. The cable connector assembly as claimed in claim 16, wherein an insulator is positioned between the first bridge and the second bridge in a vertical direction perpendicular to both said front-to-back direction and said transverse direction.

20. The cable connector assembly as claimed in claim 16, wherein an insulative housing defines a pair of tubular sections each diametrically sandwiched between the inner tube and the outer tube of the corresponding connector.
